(19) United States
(12) Patent Application Publication
(10) Pub. No.: US 2013/0268606 A1
(43) Pub. Date: Oct. 10, 2013

(54) System and Method for Determining and Presenting a Status from Multiple Sources and Devices

(71) Applicant: RAPID CYBER SOLUTIONS, INC., Longwood, FL (US)

(72) Inventor: Varunita Bhatia Jindal, Longwood, FL (US)

(73) Assignee: RAPID CYBER SOLUTIONS, INC., Longwood, FL (US)

(21) Appl. No.: 13/802,214

(22) Filed: Mar. 13, 2013

Related U.S. Application Data
(60) Provisional application No. 61/685,164, filed on Mar. 13, 2012.

(51) Int. Cl. H04L 12/58

(52) U.S. Cl. CPC H04L 51/02
USPC 709/206

(57) ABSTRACT

A method and device are able to determine the status of an owner of a device based on at least two status sources. The system is also able to determine the owner's status from several different devices belonging to the same person. The status of the person is then transmitted to others using the system, using a symbol that is also colored to reflect the type of contact and the status of the owner. A determination of whether to send an alert out is also provided.

### REFERENCE TO RELATED CASE

This application claims priority under 35 U.S.C. §119 (e) to provisional application No. 61/685,164, filed on Mar. 13, 2012, which is hereby incorporated by reference in its entirety.

### BACKGROUND OF THE INVENTION

### Field of the Invention

Today in the world of instant communication, the status or availability of a person with whom you would like to communicate is an important piece of information. The people or end-users of communication systems set their status in such systems to inform others of their status and availability, and to manage the expectations of others regarding the response times. In a typical instant messaging system, an end-user selects the status from one of a variety of preset options and changes that person's status in the communication system for others to see. The setting of one's status is a very manual process. The end-users have to manually open the Instant Messaging systems and navigate through several if not many screens to change the status on those communication systems. One of the drawbacks of such a system is the person has to remember to change the status whenever their own true status changes. If not, then the person is notifying others of an incorrect status. This can reduce the messages that the person wants or needs to see. It also limits any potential conversations with others.

Also, in this world of instant communication, the end-user's status may also be available from multiple sources and devices. For example, the end-user can show the status in an Instant Messaging system as “Available” but the calendar system can show the status as in the “Meeting.” Such conflicts make the status information ineffective for the other end-users.

There is a need to prioritize the status information available across several different sources and devices and then present the right information to the other end-users.

### SUMMARY OF THE INVENTION

The present invention is directed to method of notifying others about a status of an operator of a device that includes the steps of determining a status value of the operator of the device based on input from at least two status sources, determining which of the at least two status sources has the most current status value, identifying the most current status value, and assigning the most current status value as the status of the operator.

In some embodiments, the at least two status sources are selected from the group consisting of a programmable status source, a calendar status source, and a manual status source.

In some embodiments, the method also includes the step of transmitting to others the status of the operator of the device.

In yet other embodiments, at least one of the at least two status sources is on a second device.

In yet another embodiment, the status of the operator of the device is displayed at least in part as a symbol, the symbol corresponding to a relationship between the operator and a recipient of the status and having a having a color corresponding to the status of the operator, and as a number reflecting time that the operator has been in the same status.

In yet another aspect, the invention is directed to a method of determining whether a message is to be sent by a third party to a device operator based on a current status of the device operator that includes the steps of determining the current status of the device operator, determining the relationship of the device operator to the third party, determining the location of the device operator relative to the third party, and sending the message to the device operator only if the current status of the device operator is known and does not prohibit the sending of the message, has a predetermined relationship to the third party, or is located within the same time zone as the third party.

In yet another aspect, the present invention is directed to method of displaying a status of an operator of a device including the steps of receiving information about the status and identity of the operator of the device in a second device, displaying the status of the operator of the device on the second device, the status being displayed as a symbol, the symbol having a having a color corresponding to the status of the operator, and with a number reflecting an amount of time that the operator has been in the status.

In yet another aspect, the present invention is directed to a device for notifying others about the status of a user of the device using the method of claim 1, the device comprising, a memory, a processor to implement the steps of determining, identifying, and assigning, a user input, a display, a transmitter to transmit the status to others, and a receiver to receive information related to the steps.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description of the present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and, together with the description, serve to explain the principles and operations of the invention.

### BRIEF DESCRIPTION OF THE DRAWINGS

FIG. 1 is a diagram illustrating the environment for one embodiment of a system according to the present invention;

FIG. 2 is a flowchart illustrating one method of updating and transmitting the status of a owner of a device to others;

FIG. 3 is a flowchart illustrating one method of determining a status value of the owner;

FIG. 4 is a chart illustrating priority and status sources according to one embodiment of the present invention;

FIG. 5 is a plan view of one device that may be use with the system in FIG. 1;

FIG. 6 is a representation of a screen shot of the contact screen that can be used with the present invention;

FIG. 7 is a representation of a screen shot of a favorite contact screen that can be used with the present invention;

FIG. 8 is a representation of a screen shot of a settings screen that can be used with the present invention;

FIG. 9 is a representation of a screen shot of a calendar screen that can be used with the present invention;

FIG. 10 is a representation of a screen shot of a programmable status screen that can be use with the present invention;

FIG. 11 is a representation of a screen shot of an editing screen for the programmable status screen that can be used with the present invention;

FIG. 12 is a representation of a screen shot of the manual status screen that can be used with the present invention;

FIG. 13 is a representation of a screen shot of the inactivity timeouts screen that can be used with the present invention; and

FIG. 14 is flowchart illustrating the determination of sending an alert to another device over the system according to the present invention.

### DETAILED DESCRIPTION OF THE PREFERRED EMBODIMENTS

Reference will now be made in detail to the present preferred embodiment(s) of the invention, examples of which are illustrated in the accompanying drawings. Whenever possible, the same reference numerals will be used throughout the drawings to refer to the same or like parts.

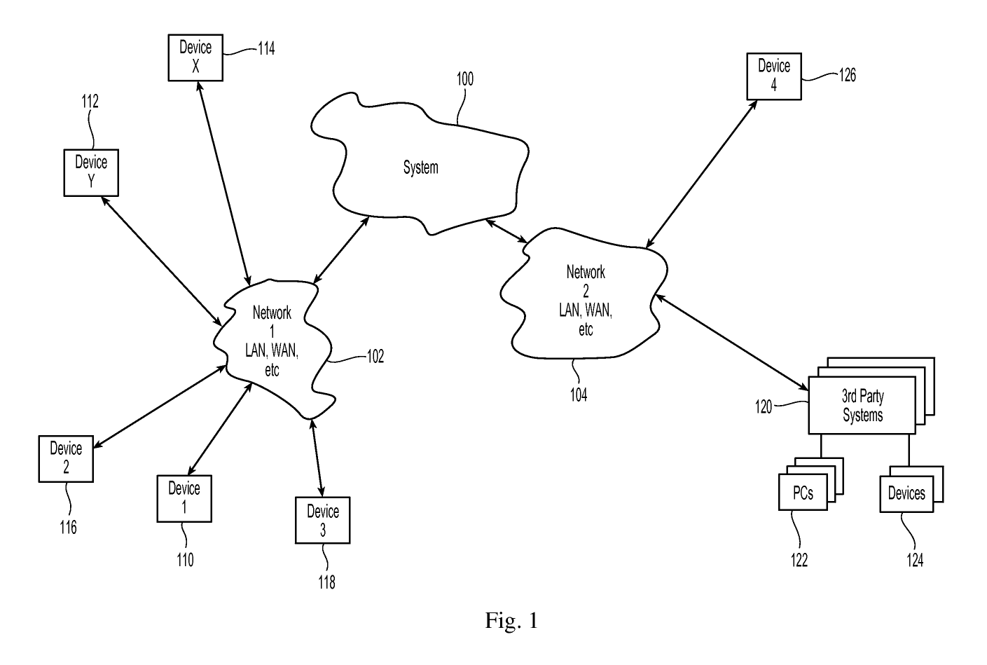

Referring to FIG. 1, a system 100 is connected to networks 102,104 to allow communication from the networks to the system 100. While there are two networks as being illustrated, more networks may be in communication with the system 100. Network 102 can be any type of appropriate network; a wired one, a wireless one, a cellular network, etc. Network 104 as illustrated is a network that can be a LAN, a WAN, etc. Devices are in turn attached to the networks 102,104 so the people who are associated with the devices may communicate with one another. As illustrated, a device 110 is in communication with the network 102 in either a wireless or a wired fashion. The device 110 is usually a mobile device but may also be not so mobile and may include a telephone, a cellular phone, a tablet, a personal computer, a hand-held communicator, a lap top, etc. Device 112 is owned by a different person from the person who owns device 110. The devices 110 and device 112 may communicate with one another through the network 102 (through their owners). Similarly, device 114 is owned by yet another person and is able to communicate with the owners of devices 110 and device 112 through the network 102. It is also possible that the person who owns device 110 also owns other devices 116,118 that are also connected to the network 102. For example, a person may have a tablet, a second cellular phone, a pager, etc., which are all connected to the network 102.

Network 104, also connected to the system 100 in a typical manner. The network 104 is connected to third party systems 120, such as Microsoft Office Communicator, Microsoft Lync, Google Talk, Skype, Yahoo Messenger, etc., which in turn allows for personal computers 122 and other electronic devices 124. As noted, other devices 126 may be connected directly to the network 104. These other devices 126 may include a tablet, a second cellular phone, a pager, etc.

Through system 100, the users with devices that are connected to networks 102,104 can get an updated status of the other users on the networks 102,104 based on certain criteria, which is discussed in detail below. System 100 is comprised of Routers, Load Balancers, Servers, Data Bases, Storage, Archive, etc. It is also where the executable instructions reside for performing the steps discussed in detail below.

The owners or users of the devices like to know what the status of others with whom the users are having a conversation. For example, two people may be communicating information back and forth about a project they are working on. If one person requests information and the other person fails to respond, the first person does not know if the person received the request, is simply ignoring the request, or is busy with something else at the moment and is unable to respond. This is particularly true if they have been corresponding back and forth for a while and expectations have been set. If the first person were able to see that the other person was busy, away from the phone, on the telephone, etc. then it relieve some of the anxiety and unnecessary concern on that person's behalf. Of course, the second person may not want the first person to know everything about the status, so it would be beneficial if the second user were able to decide how much information about their status is shared with the other users.

System 100 allows for users of devices (110, 112, 114, etc.) to share a status with other users. The status of the user can range from a low availability setting up to a very high availability. For example, the settings from lowest to highest availability, in one embodiment, include Out Of Office, Offline, Away, Do Not Disturb (DND), Busy, Idle, and Available. Other descriptions, more or fewer descriptions of the availability of the user could also be used and still fall within the scope of the present invention.

For the system to determine what the device owner's status is, the status is collected from multiple status sources. For example, in many systems, the person can manually set a status on their cellular phone. However, the person may have set the status to “Available” and forgot to change it before they went into a meeting, or went to bed for the evening. Thus, it would be beneficial to the user of the device as well as those with whom they want to share their information that the status information is as correct as possible.

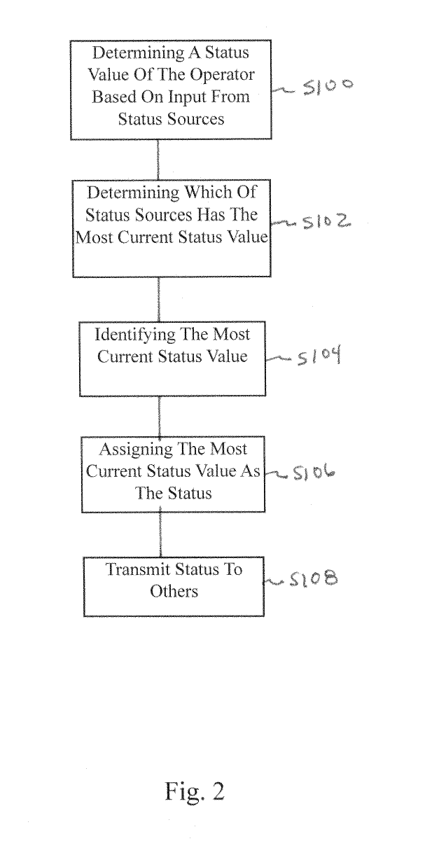

Turning to FIG. 2, a method is illustrated for notifying others about the status of the device owner. In step S100, the system determines which sources have status information about the device owner. For example, the device 110 may have a manual status set to one value. Device 110 may also have a calendar (or even more than one calendar) that the owner uses to schedule meetings, to record times that they are not be disturbed, or even to indicate that they are available for meetings. The device 110 may also use a programmable status that the person can set in advance for routine and planned times that may not be recorded or accounted for in other ways. For example, the owner of device 110 may program dinner with their family every day from 6:00 pm until 8:00 pm, or that they will sleep from 10:00 pm until 6:00 am every weekday. While some of the times that are programmed may be entered on a calendar, other times are not appropriate for a calendar but the status needs to be updated, e.g., DND for that Saturday morning golf game.

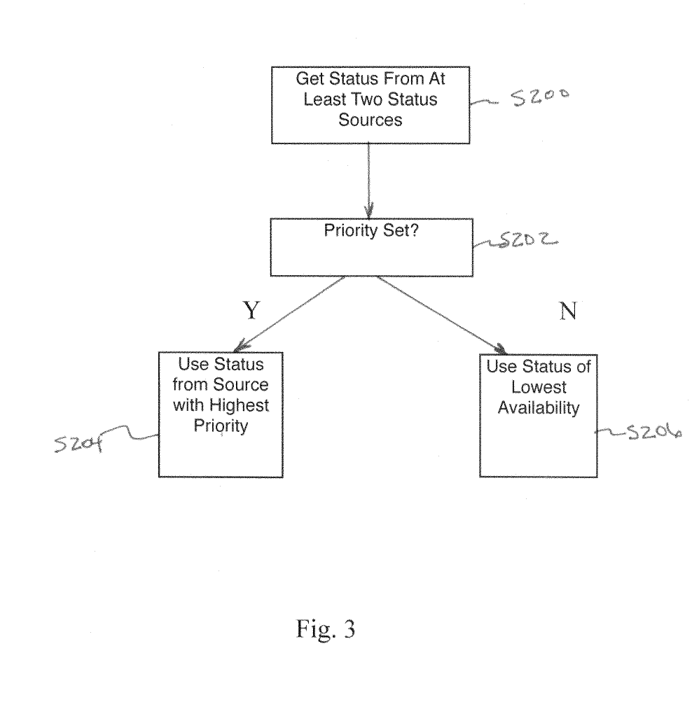

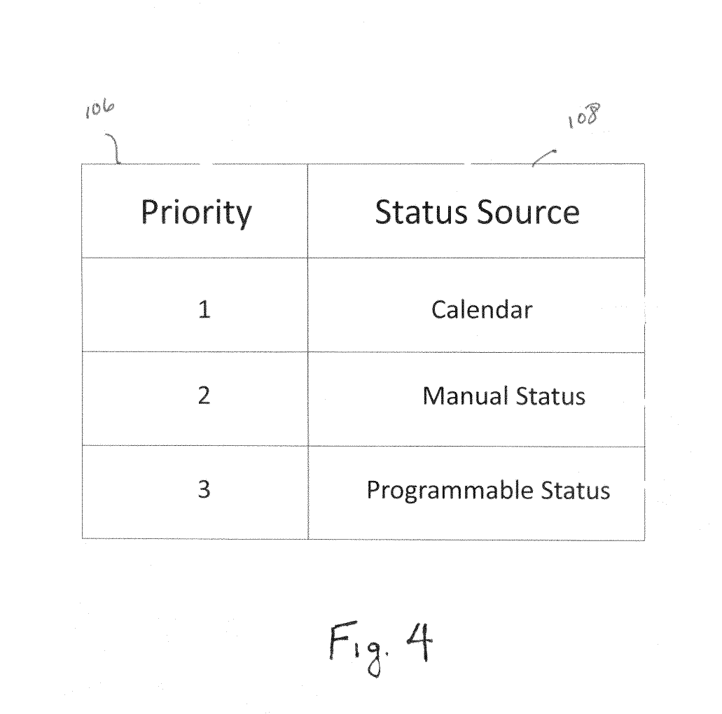

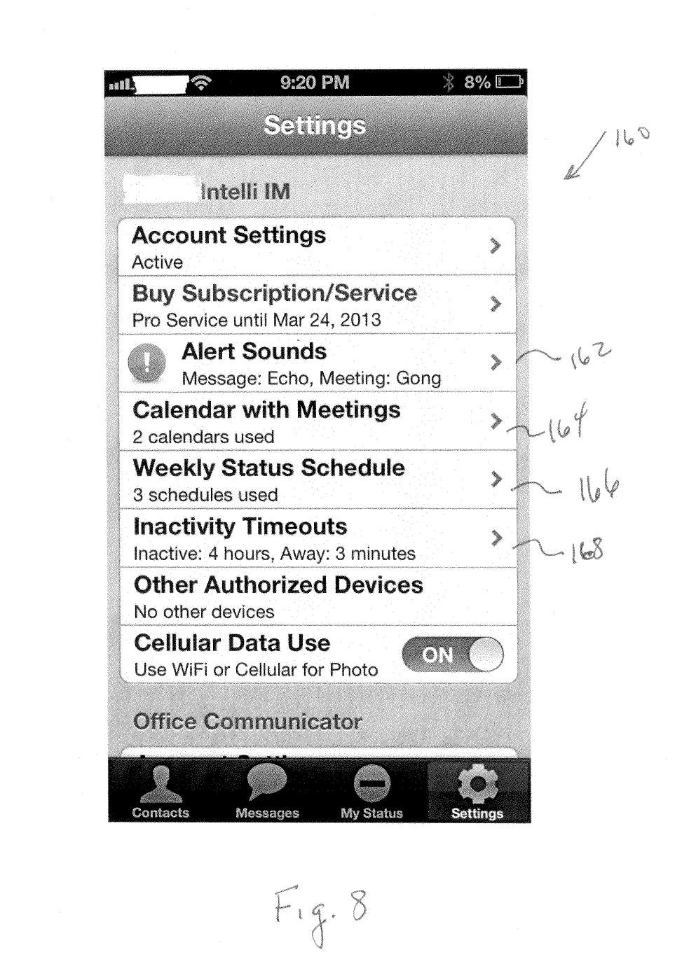

The system 100 gets the status from multiple status sources (manual, programmed, and calendar, etc.) to determine what each of the status sources has a value for the status of the device owner. Additionally, if the owner of device 110 has more than one device, e.g., in this case, the system 100 gets the status from each of the status sources on those devices as well. This is particularly useful if the devices are not all on the same operating platforms and they are not synced with one another. Even if they are all on the same platform, the owner may not have synced them at the time the system 100 needs to retrieve the information. The system 100 then determines which of the status sources has the most current status value at step S102 in one of two ways as illustrated in FIGS. 3 and 4. When the owner of device 110 sets up the device to communicate with system 100, the device 110 has software (a native application for that particular device or through a web application) installed on the device to assist in communication and setup with system 100. See also FIG. 8. In the set up of the device 110, the user can select the priority of the status sources. See FIG. 4. For example, there were three status sources (calendar, programmable, manual) noted above and the user can then prioritize those three status sources in case the status values from the three status sources are not the same. As illustrated in FIG. 4, the priority 106 is set for each of the status source 108, with the priority being the highest for the calendar, middle priority for the manual status and lowest priority for the programmable status. Returning to FIG. 3, the system 100 has at step S200 obtained the status from the sources available for a particular owner/device and also determined if the user has set the priority for each of the status sources at step S202. if the owner has set a priority for the status sources, then the system 100 uses the status indicated from the status source with the highest priority at step S204. In the case illustrated in FIG. 4, that would be the calendar. If the owner has not set the priority in step S202, then the system 100 uses the status source with the status having the lowest availability status value at step S206. The procedure can be done across multiple devices. This status value is then returned to the system 100, which at step S104 identifies that status value as the most current status value of the owner of the device. Finally, at step S108, the status value of the owner is transmitted to other users 112, 114 of the system 100.

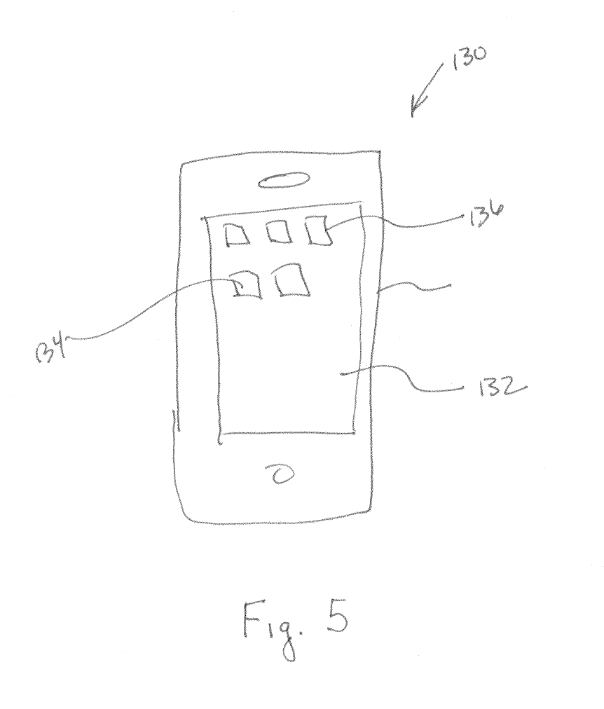

Turning now to the particulars of the system and the settings that are available to the owner of the device, reference is made to FIG. 5, illustrating a device 130. It should be noted that the device 130 could be a specific device used as illustrated devices 110,116, or 118. Device 130 is illustrated as a smart phone, but could be any device as noted above. The device 130 has a display 132 that allows the owner to interact with the device 130. The display 132 has icons 134,136 that allow the owner to select certain programs and functions. For example, icon 134 is the icon related to the system 100. Icon 136 may be the calendar that is running on the device 130, allowing the owner to add meetings, appointment, etc. into the calendar. The display 132 also has a keyboard that can be displayed to allow the user to enter data and selections. The device 130 also includes a memory, a processor, and a transmitter and a receiver or a transceiver for communication to the network.

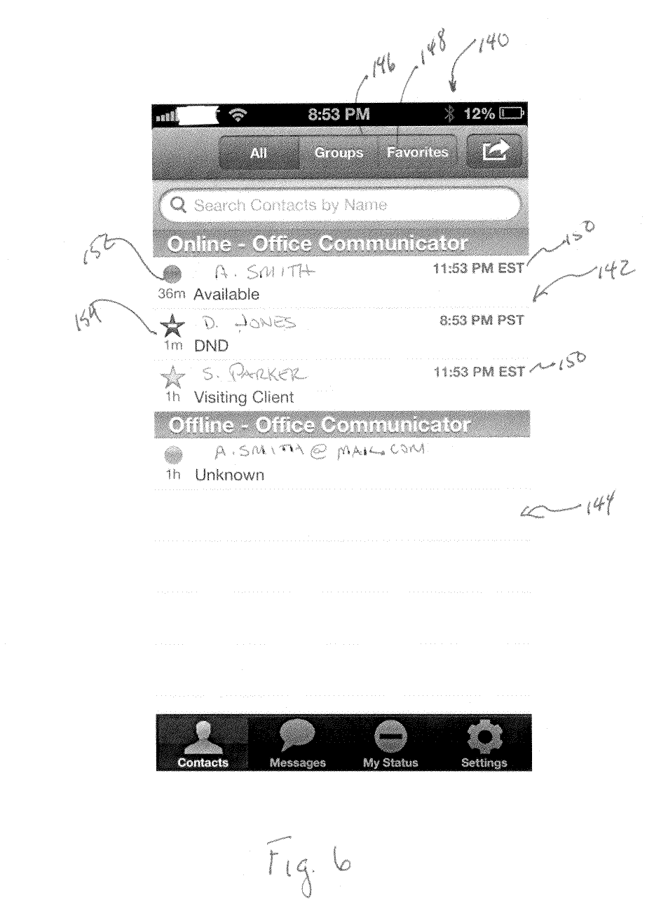

For the owner to notify others on the system 100, the owner will have to have the other person's information, including their telephone number or email address. This can be done through the contacts that the owner has on the device 130. A view of the contact screen 140 used with system 100 on the device 130 is illustrated in FIG. 6. The contacts are shown in two different portions 142,144 of the contact screen. The upper portion 142 shows those contacts that are currently on line and the bottom screens 144 shows those contacts that are offline. As indicated that the top of the screen, the contacts listed are all of the contacts. It is possible, as with most contact lists, to have a group of contacts 146, and a favorites list 148. The contacts each have a have on the right side of the contact screen 140 a time 150 where the contact is located. As illustrated in FIG. 6, the three contacts in the upper portion 142 are in two different time zones. And those two are in a different time zone than the owner, given that the owner's time is illustrated at the top of the contact screen 140.

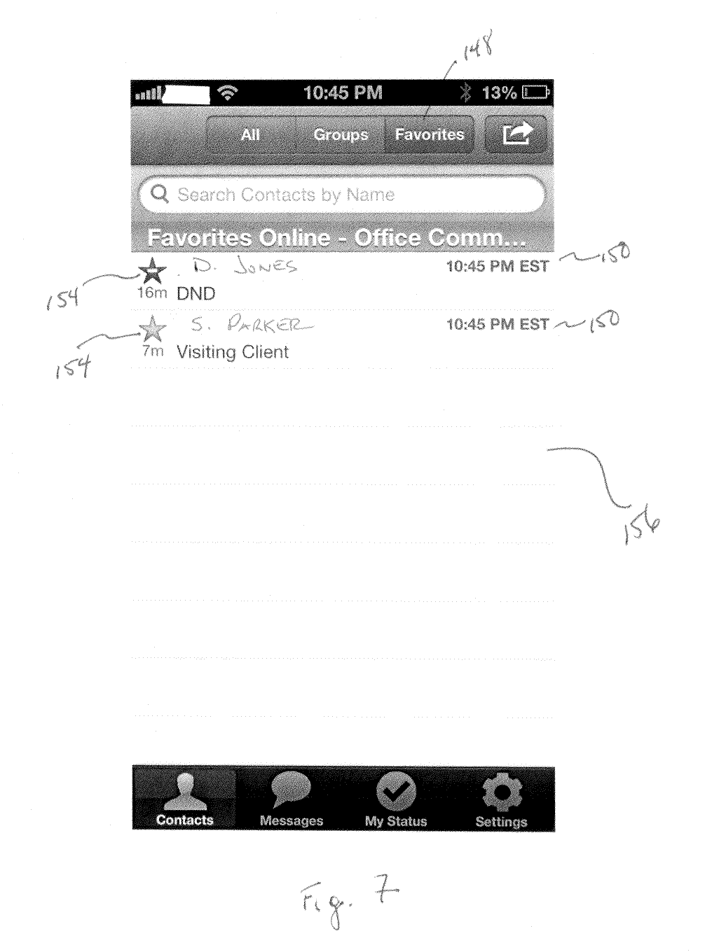

Each of the contacts also has a status symbol 152, 154 on the left side of the contact's name. As illustrated in FIG. 6, the symbol 152,154 can be different for different contacts. For example, the circle symbol 152 can represent just an acquaintance or simply just a contact. The star symbol 154 can represent a contact that is a favorite. Turning to FIG. 7, the contact screen 156 is illustrated for the Favorites in the owner's contact list. Other symbols can be used to further differentiate the contacts. For example, family members can have a heart symbol associated with their contact information so the owner can see the family members' status more easily and quickly. Other symbols can be used for work colleagues or for those working on a special project. The contacts in the Favorites section of the contacts have, as discussed below, a special status for the delivery of alerts and status information. The symbol 154 corresponding to each of the contacts is assigned at the device level. That is, the status and the time of the status update is received by the device (e.g., device 130), but the system 100 does not transmit the symbol or the length of time that contact has been in the same status. Rather, the device (e.g., device 130) that receives the information about the status determines which of the symbols to display next to the contact's name (i.e., a heart, a star, a circle, etc.) based on the relationship of the two parties. Additionally, the display of the time that the contact has been in that status is also determined by the local device. The local device knows the time that the status was updated and calculates the time since the status was updated and displays that time with the colored symbol 154.

The symbols also have associated therewith a color. The inside of the symbols can be colored to reflect the update status of the contact. For example, a green circle indicates that the person is available as for the first contact in FIG. 6. The red color with a white bar in it means DND or do not disturb. Yellow can mean that the person is “away.”

Also on the left side of the contact pages is an indication of the status. As illustrated in FIG. 6, the first contact is available, while the second contact is a favorite and not to be disturbed. The third contact is a favorite with a busy status and a note indicating that they are visiting a client.

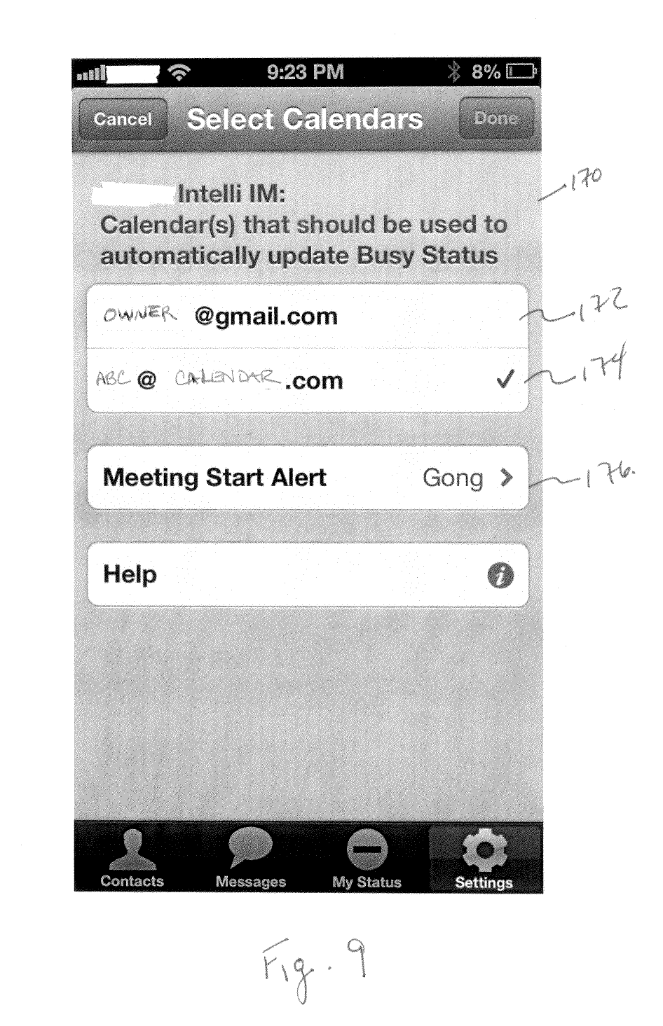

FIG. 8 illustrates on setting screen 160 that allows the owner to set up the system 100 to fit the owner's needs. In area 162, the owner can set the alert sounds that accompany each of the functions of the system. For example, a tone can be set for when a status is updated, when a message that is sent through the system is received, etc. In area 164, the owner can set identify the calendars that the owner uses so that the system 100 can get the status from each of the calendars as noted above. FIG. 9 illustrates the calendar selection screen 170. As illustrated on the selection screen, 2 calendars 172, 174 have been identified for use by the system 100 to update the status value of the owner. The system 100 can also be used to notify the owner of a meeting that is recorded in one of the calendars 172, 174 by use of an alert 176.

Returning back to FIG. 8, the programmable status area 166 is also presented under the settings screen 160. As noted above, the owner can set a schedule for the system 100 to set the owner's status.

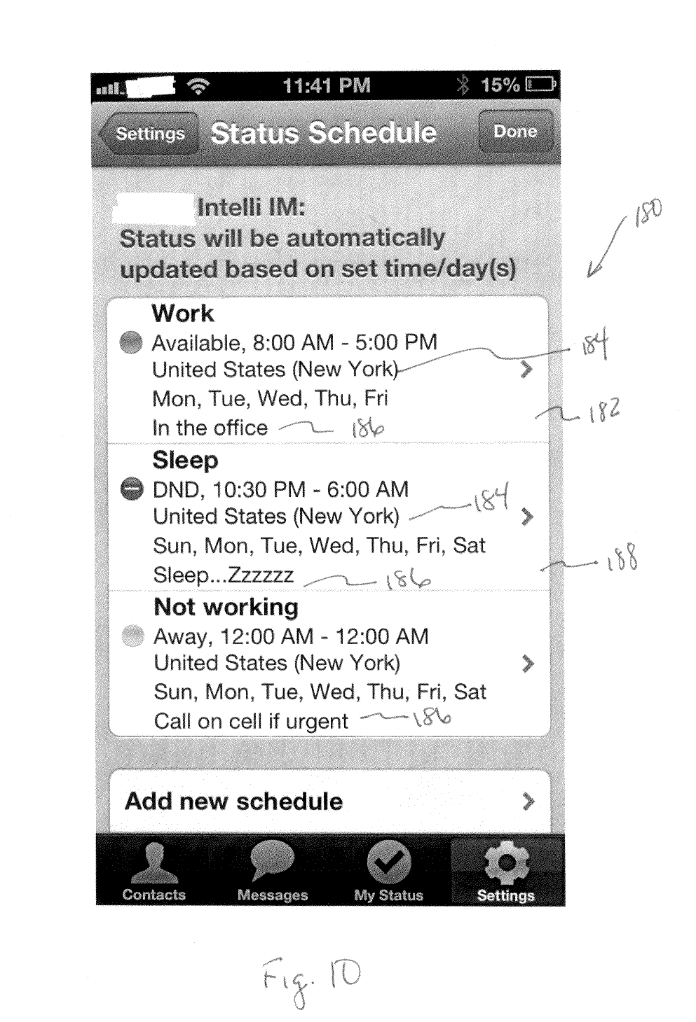

As illustrated in FIG. 10, there are three programmed schedules on the status schedule screen 180. A schedule for work 182 is illustrated with the owner being available from 8 AM to 5 PM during the week. The schedule for work 182 also reflects at 184 the time zone where the owner of the device 130 is located. As noted above with regard to the symbols 152 and 154, a note 186 may also be entered by the owner. A second schedule for sleeping 188 is also illustrated in FIG. 10. Other schedules can also be added on the status schedule screen 180.

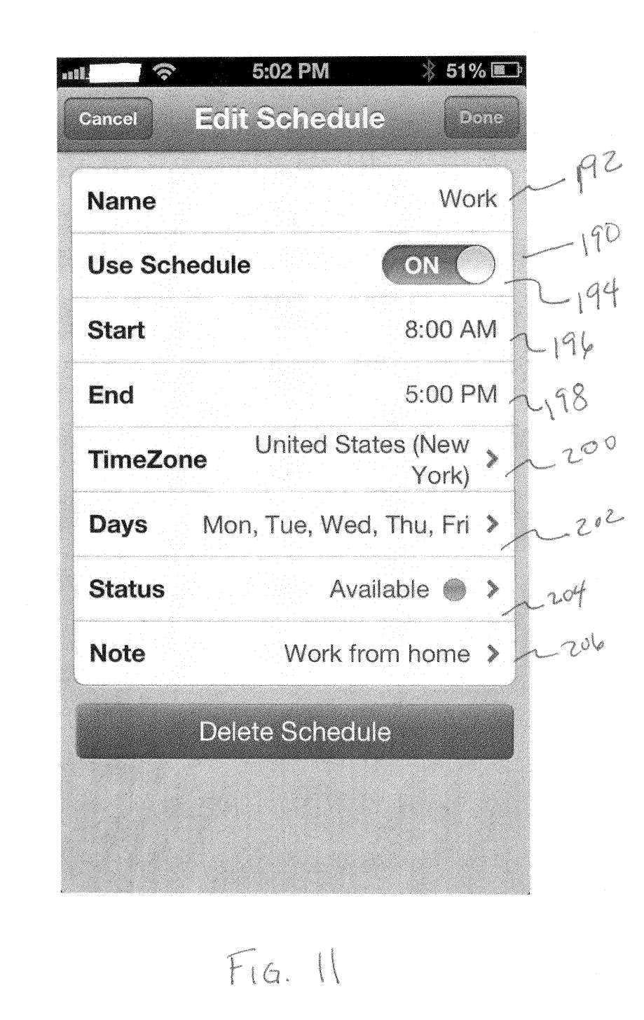

FIG. 11 illustrates an edit schedule screen 190 where the owner of the device 130 can make changes to or add a new programmable status (as reflected in FIG. 10). The edit schedule screen 190 illustrates in particular the schedule for work 182 of FIG. 10. The name 192 of the schedule can be added. The user is able to select at 194 if the programmable schedule is to be used to determine the owner's status. The start and stop time for the particular programmable status can be entered at 196 and 198, respectively. A time zone can be selected at 200 or so that the system 100 can provide the appropriate time indication 150 (see FIG. 6) and also to be able set the correct status across several time zones and status sources. The particular days of the week that the work status 192 is valid can be selected at 202. The status 204 for this particular programmable status is selected from the edit schedule screen 190. Finally, the note at 206 can be added so that it appears in the contact screen 140 under the contact's name. See, e.g., FIG. 6.

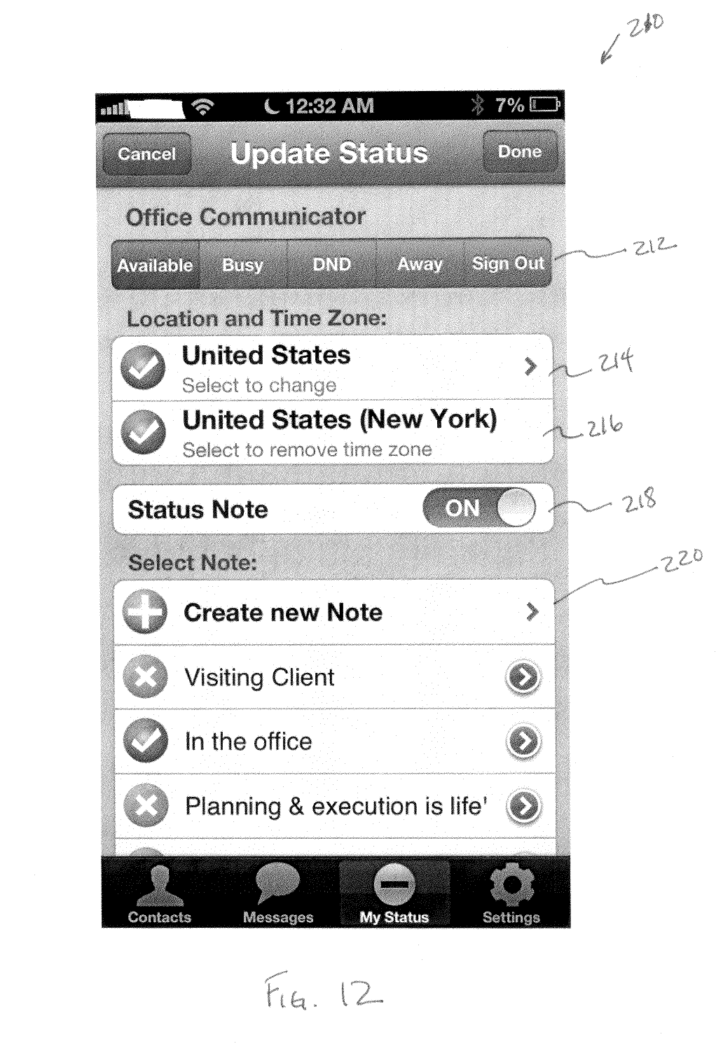

FIG. 12 illustrates the manual status update screen 210. At the top of the screen 210, the owner can select one of five status options at 212. While the options of Available, Busy, DND, Away, and Sign Out are shown, other options as well as more options may be provided to the owner.

The owner of the device 130 using system 100 is also able to select a location and time zone. As seen on manual status update screen 210, the owner can select the appropriate country where the owner is currently located at 214. Directly below that option at 216 the owner can select to display the current time zone, or unselected so the time zone is no longer available. The device may also automatically change the country and the time zone within the application.

As noted above with regard to FIG. 11, the owner of device 130 could select a note 206 to display along with the owner's status. The owner can select at 218 to display or not to display the note 206. Further in this regard, other options for selecting the note 206 as well as creating a new note is provided at 220. The owner can choose the Create new Note 220 and enter a new note that is appropriate for the owner and the situation. If no note is selected, then the status may be displayed.

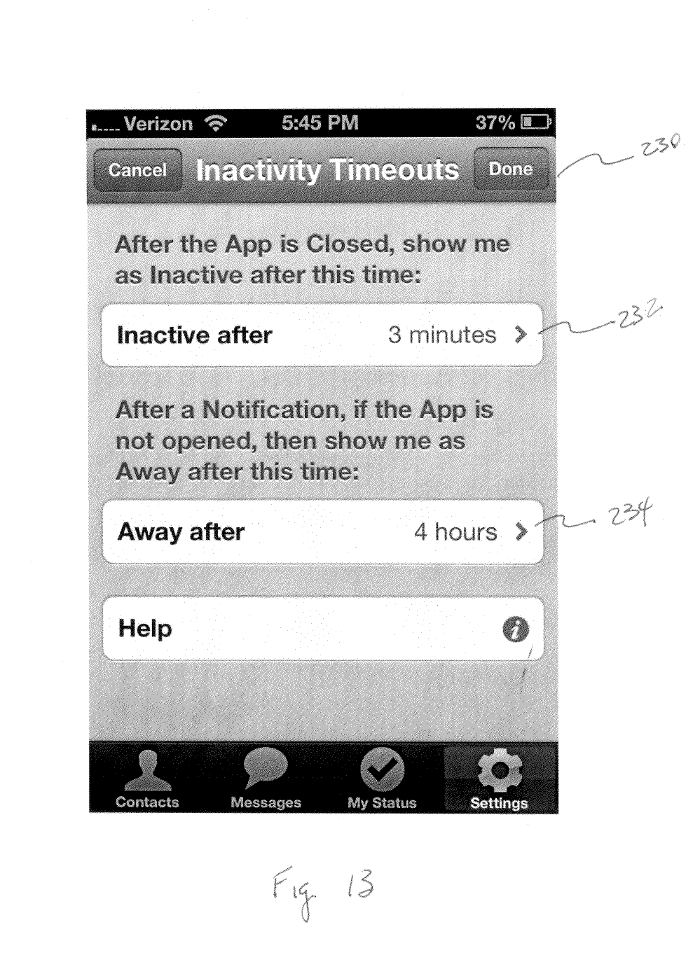

Returning to FIG. 8, the system 100 also can check on the activity of the owner based on use of the device 130 and use that activity, or lack of activity, by the owner on the device, to also update the status of the owner. At 168 in the setting screen 160, the owner can choose to set an activity time out time. As illustrated in FIG. 13, when the owner wants to change the settings of the Inactivity timeouts 168, the owner goes to the Inactivity screen 230. FIG. 13 shows the status of the owner as “Inactive” three minutes after closing the application on the device 130 as set at 232 on the Inactivity screen 230. The owner is shown as “Away” if the owner does not open the application related to system 100 on the device 130 for 4 hours after another user notice/calendar notification/message is received on device 130 at 234. The owner can, through the entries at 230 and 234, change the amount of time for each of these conditions from a preselected set of times. Similarly, the owner can set them to zero, making the Inactivity Timeouts irrelevant in the status determination.

As noted above, the owner may have multiple devices 110, 116, 118, each of which may have at least one status source associated with the devices 110, 116, 118. For example, the owner may leave a cellular device like 130 in the office and take a tablet (116 or 118) to a meeting. If the owner forgot to change the status on the phone, but changes the manual status on the way into the meeting, then the system 100 will be able to determine the correct status. Thus, the setting screen 160 has at the bottom the ability to associate other devices (such as 110, 116, 118) with the system 100, allowing the system to get information from the other devices as well.

Returning back to FIG. 2, the system 100 now is able to get information from the devices 110, 116, 118 that are owned and used by the owner. The system 100 is able to, using the settings described above and in conjunction with the priorities that have been set by the owner (or not set as the case may be) determine what the status of the user is at S106. That status is then identified by the system 100 and is the status that is transmitted to others in step S108.

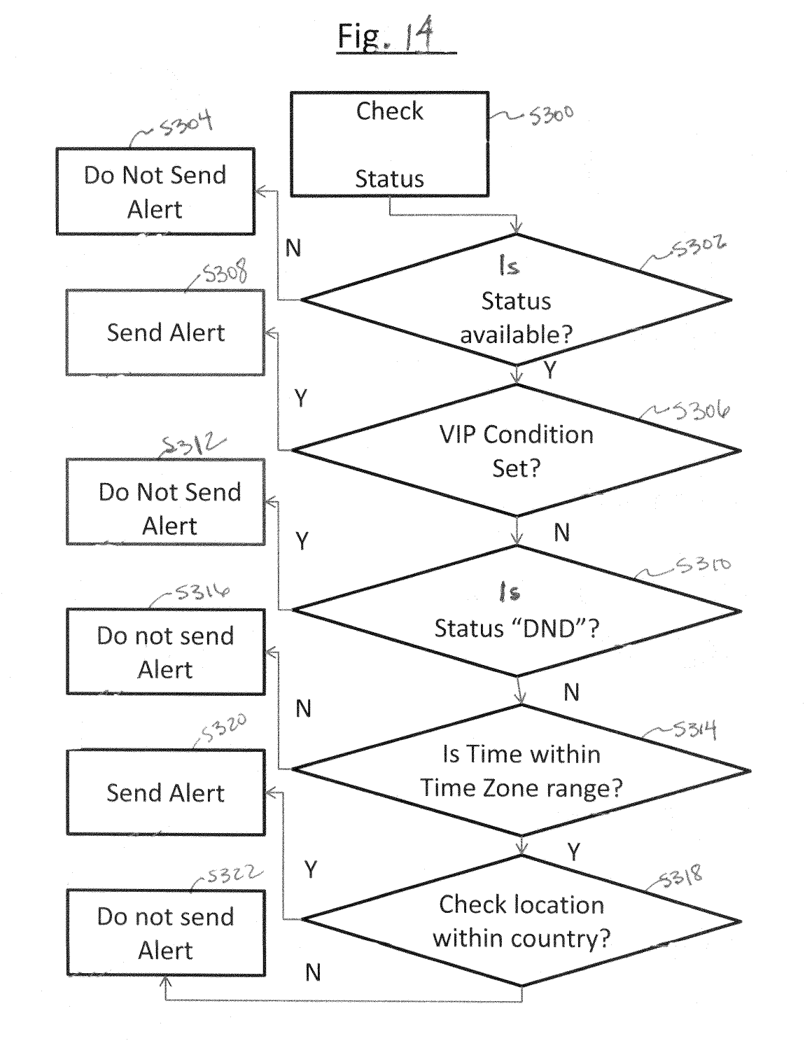

The system 100 then determines what information based on the information gathered from the owner's devices (110, 116, 118) is to be included when the status is transmitted to others 112, 114. The system 100 will also send alerts to the devices with access to the system 100 between owners who have each other as contacts. For example, the system can send alerts about contacts who status have changed, messages, or a reminder about a calendar entry. The system 100 will allow an alert to be sent only in certain situations, depending on the settings of the users on system 100. Referring to FIG. 14, the system 100 at step S300 checks the status of the contact or recipient who is supposed to receive an alert on their device. At step S302, the system 100 makes a determination if the status of the recipient is available. If the status of the recipient cannot be determined by the system 100, then the alert is not sent at step S304. However, if the recipient's status can be determined at step S304, then system 100 further determines at step S306 if the recipient is a favorite contact of the sending device. If the recipient is a favorite, then the alert is sent at step S308 regardless of the recipient's status. If the proposed recipient is not a favorite, then the system 100 checks to see if the status of the recipient is set to DND at step S310. If the status of recipient is DND, then the alert is not sent at step S312. If the status is not DND at step S310, then the system determines if the status of the recipient is within the sender's time zone at step S314. If the recipient is not within the same time zone, then the alert is not sent at step S316. If the recipient is within the same time zone, then the system 100 determines at step S318 if the recipient is within the same country. If the recipient is in the same country, then the alert is sent at step S320 and if not, then the alert is not sent at step S322.

an alert is sent to a device (110, 116, 118)

At will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

I claim:

1. A method of notifying others about a status of an operator of a device comprising the steps of:
determining a status value of the operator of the device based on input from at least two status sources;
determining which of the at least two status sources has the most current status value;
identifying the most current status value; and
assigning the most current status value as the status of the operator.

2. The method according to claim 1, wherein the at least two status sources are selected from the group consisting of a programmable status source, a calendar status source, and a manual status source.

3. The method according to claim 1, further comprising the step of transmitting to others the status of the operator of the device.

4. The method according to claim 1, wherein at least one of the at least two status sources is on a second device.

5. The method according to claim 4, wherein the second device includes a phone, a tablet, or a computer.

6. The method according to claim 3, wherein the status of the operator of the device is displayed at least in part as a symbol, the symbol corresponding to a relationship between the operator and a recipient of the status and having a having a color corresponding to the status of the operator, and as a number reflecting time that the operator has been in the same status.

7. The method according to claim 1, wherein the step of determining which status source has the most current status value further comprises:
determining a priority of the status sources available to the device operator, the priority of each of the status sources having been previously assigned by the device operator;
comparing the priorities of each of the status sources; and
identifying the status source having the highest priority.

8. The method according to claim 2, wherein the programmable status source includes a status value based on a pre-entered schedule for the device operator.

9. The method according to claim 2, wherein the programmable status source includes a status value based on usage of at least one device associated with the operator, the value being programmable by the operator.

10. The method according to claim 2, wherein the calendar status source includes an indication derived from calendar entries in at least one calendar associated with the device operator.

11. The method according to claim 2, wherein the manual status source includes an indication from the device operator of the operator's status.

12. The method according to claim 1, wherein the step of determining which status source has the most current status value further comprises:
determining the status value of each of the status sources if a priority of the status sources has not been assigned, the status values having a set of values ranging from highest to lowest;
identifying the lowest status value of the status sources; and
setting the most current status as the lowest status value.

13. The method according to claim 12, wherein the status values are chosen from the group consisting of out of office, offline, away, do not disturb, busy, and available.

14. A method of determining whether a message is to be sent by a third party to a device operator based on a current status of the device operator comprising the steps of:
determining the current status of the device operator;
determining the relationship of the device operator to the third party;
determining the location of the device operator relative to the third party; and
sending the message to the device operator only if the current status of the device operator is known and does not prohibit the sending of the message, has a predetermined relationship to the third party, and is located within the same time zone as the third party.

15. The method of determining whether a message is to be sent to a device operator according to claim 14, wherein the step of determining the status of the device operator comprises the steps of:
determining a status value of the operator of the device based on input from at least two status sources, the at least two status sources selected from the group consisting of a programmable status source, a calendar status source, and a manual status source;
determining which status source has the most current status value;
identifying the most current status value;
assigning the most current status value as the status of the operator.

16. The method of determining whether a message is sent to a device operator according to claim 14, wherein the message sent is an update of the current status of the device operator.

17. The method of determining whether a message is sent to a device operator according to claim 14, wherein the step of determining the location of the device operator relative to the third party comprises identifying if the device operator is in the same time zone.

18. The method of determining whether a message is sent to a device operator according to claim 14, wherein the step of determining the location of the device operator relative to the third party comprises identifying if the device operator is in the same country.

19. A method of displaying a status of an operator of a device comprising the steps of:
receiving information about the status and identity of the operator of the device in a second device;
displaying the status of the operator of the device on the second device, the status being displayed as a symbol, the symbol having a having a color corresponding to the status of the operator, and with a number reflecting an amount of time that the operator has been in the status.

20. A device for notifying others about the status of a user of the device using the method of claim 1, the device comprising:
a memory;
a processor to implement the steps of determining, identifying, and assigning;
a user input;
a display;
a transmitter to transmit the status to others; and
a receiver to receive information related to the steps.
